(19) United States
(12) Patent Application Publication
(10) Pub. No.: US 2017/0366059 A1
(43) Pub. Date: Dec. 21, 2017

(54) POWER SUPPLY RING

(71) Applicant: Yazaki Corporation, Tokyo (JP)

(72) Inventors: Hayato IIZUKA, Shizuoka (JP); Naoki FUJIMOTO, Shizuoka (JP)

(73) Assignee: Yazaki Corporation, Tokyo (JP)

(21) Appl. No.: 15/623,443

(22) Filed: Jun. 15, 2017

(30) Foreign Application Priority Data
Jun. 17, 2016 (JP) 2016-120464

(51) Int. Cl. H02K 3/28; H02K 3/30

(52) U.S. Cl. CPC H02K 3/28; H02K 3/30

(57) ABSTRACT

A power supply ring includes bus rings which are provided for each phase of a rotating machine having a plurality of stator coils arranged side by side in an annular shape and extends in a circumferential direction to extend along the plurality of stator coils; power supply terminals for each phase which electrically connect the bus rings to a power source side; and a plurality of coil connection terminals which electrically connects the bus rings to each of the stator coils of the same phase, in which each of the bus rings is concentrically laminated on an annular body including the plurality of stator coils in an axial direction.

### CROSS-REFERENCE TO RELATED APPLICATION(S)

The present application claims priority to and incorporates by reference the entire contents of Japanese Patent Application No. 2016-120464 filed in Japan on Jun. 17, 2016.

### BACKGROUND OF THE INVENTION

### 1. Field of the Invention

The present invention relates to a power supply ring.

### 2. Description of the Related Art

Conventionally, an annular power supply ring connected to an annular stator in a rotating machine for each phase and constituting a stator unit together with the stator has been known. The power supply ring is responsible for supplying a current for each phase between the stator and an inverter. The power supply ring includes an annular bus ring (conductor) for each phase, a power supply terminal provided for each bus ring to electrically connect the bus ring to the inverter side, and a coil connection terminal which electrically connects the bus ring to the respective stator coils for each phase. By concentrically arranging the bus rings of each phase side by side in a radial direction, the power supply ring can suppress an increase in the body size of the stator unit in an axial direction. This kind of power supply ring is disclosed in, for example, Japanese Patent Application Laid-open No. 2007-135339.

Incidentally, in the conventional power supply ring, in order to ensure insulation properties between the respective bus rings, an annular spacer is interposed between the bus rings which are adjacent to each other in the radial direction. For this reason, in the conventional power supply ring, there is risk of an increase in the body size in the radial direction, and there is a possibility of an increase in the body size of the stator unit in the radial direction. Further, the conventional power supply ring is disposed on the outside in the radial direction with respect to the stator coil, which also leads to an increase in the body size of the stator unit in the radial direction.

### SUMMARY OF THE INVENTION

Thus, an object of the present invention is to provide a power supply ring capable of suppressing an increase in the body size of the stator unit.

A power supply ring according to one aspect of the present invention includes a bus ring which is provided for each phase of a rotating machine having a plurality of stator coils arranged side by side in an annular shape and extends in a circumferential direction to extend along the plurality of stator coils; a power supply terminal for each phase which electrically connects the bus ring to a power source side; and a plurality of coil connection terminals which electrically connects the bus ring to each of the stator coils of the same phase, wherein each of the bus rings is concentrically laminated on an annular body including the plurality of stator coils in an axial direction.

According to another aspect of the present invention, in the power supply ring, it is preferable that each of the bus rings is disposed to be placed between an outer wall surface side and an inner wall surface side on the annular body including the stator coil when viewed in the axial direction.

According to still another aspect of the present invention, in the power supply ring, it is preferable that each of the bus rings is concentrically disposed side by side in a radial direction, a connecting position with the power supply terminal and a connecting position with the coil connection terminal being provided on the same plane as a main body portion extending in the circumferential direction, and the power supply terminal and the coil connection terminal are disposed such that a longitudinal direction of the terminals extends along a plane orthogonal to the axis.

According to still another aspect of the present invention, it is preferable that the power supply ring further includes a plurality of holding members which collectively bundles and holds each of the bus rings in a state of being spaced from each other in the radial direction.

According to still another aspect of the present invention, in the power supply ring, it is preferable that the holding member has an engaging portion which fixes each of the bus rings to the stator by being engaged with a portion to be engaged provided in the stator.

According to still another aspect of the present invention, in the power supply ring, it is preferable that the portion to be engaged is provided in a coil insulator of the stator coil.

According to still another aspect of the present invention, in the power supply ring, the bus ring includes a conductive member extending in a circumferential direction along the plurality of stator coils, and an insulating coating which covers the conductive member, and the coating is an ultraviolet cured coating formed of an ultraviolet curable resin.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a power supply ring and a stator of an embodiment;

FIG. 2 is a perspective view illustrating a state in which the power supply ring of the embodiment is assembled to the stator;

FIG. 3 is a top view illustrating a state in which the power supply ring of the embodiment is assembled to the stator;

FIG. 4 is a side view of the power supply ring of the embodiment;

FIG. 5 is an exploded perspective view of the power supply ring of the embodiment disassembled for each bus ring;

FIG. 6 is an exploded perspective view illustrating a U-phase bus ring;

FIG. 7 is an exploded perspective view illustrating a V-phase bus ring;

FIG. 8 is an exploded perspective view illustrating a W-phase bus ring;

FIG. 9 is an exploded perspective view illustrating a neutral-phase bus ring;

FIG. 10 is an exploded perspective view illustrating a state before a holding member is attached;

FIG. 11 is a perspective view of the holding member;

FIG. 12 is a side view of the holding member;

FIG. 13 is a top view of the holding member; and

FIG. 14 is a side view illustrating a modified embodiment of the holding member.

### DETAILED DESCRIPTION OF THE PREFERRED EMBODIMENTS

Hereinafter, embodiments of a power supply ring according to the present invention will be described in detail with reference to the drawings. The present invention is not limited by the embodiments.

### Embodiment

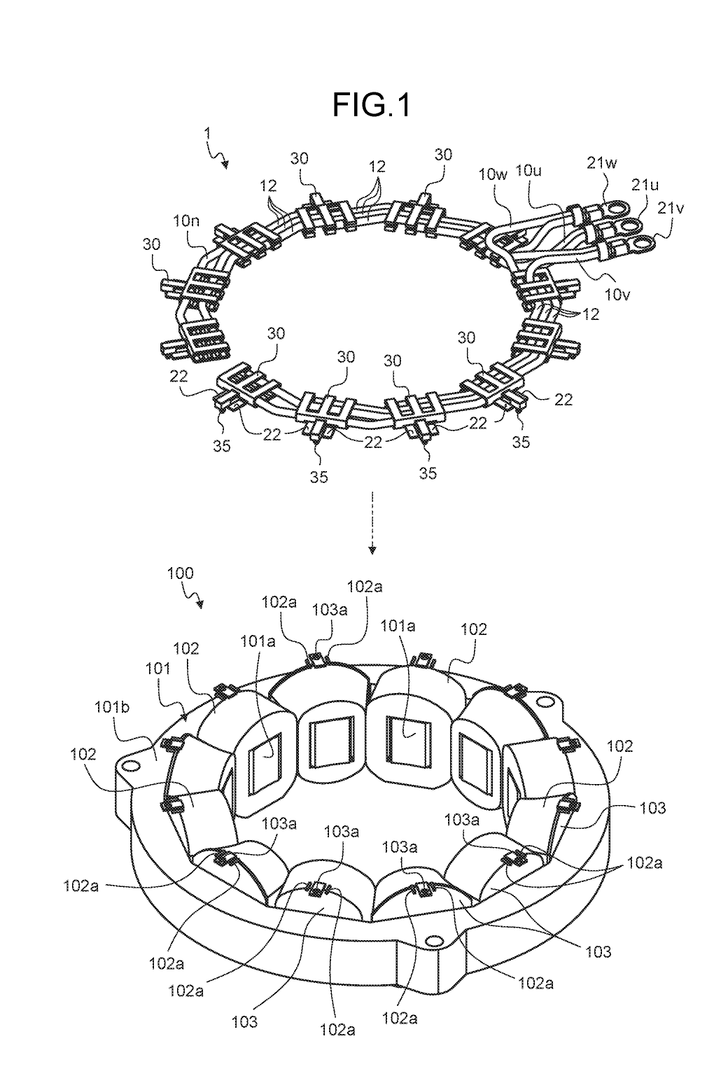

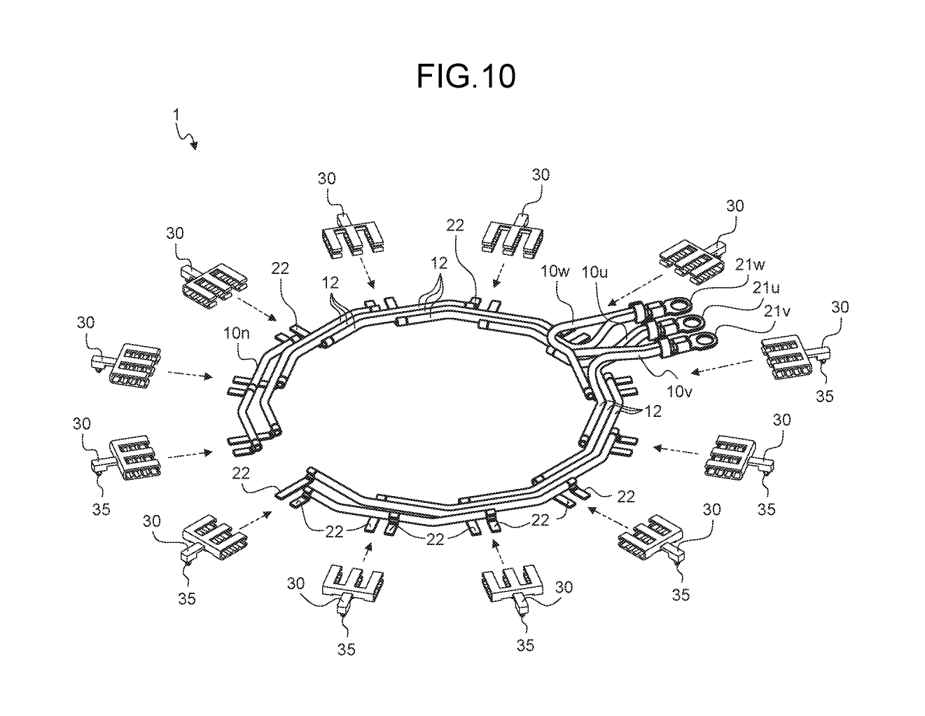

An embodiment of the power supply ring according to the present invention will be described with reference to FIGS. 1 to 14.

The reference sign 1 in FIGS. 1 to 4 indicates a power supply ring of the embodiment. The power supply ring 1 is a power supply structure that is responsible for supplying current for each phase of a rotating machine between, for example, a stator 100 of the rotating machine mounted on a vehicle and a power source (not illustrated) of a secondary battery or the like. For example, when the rotating machine is operating as an electric motor, electric power sent from an inverter of the secondary battery side is supplied to the rotating machine via the power supply ring 1. Further, when the rotating machine is operating as a generator, such as during regeneration, the electric power generated by the rotating machine is supplied to the inverter via the power supply ring 1, and is charged to the secondary battery via the inverter. By being attached to the stator 100, the power supply ring 1 and the stator 100 form a stator unit.

Here, the stator 100 includes a stator core 101. The stator core 101 has a plurality of teeth 101a arranged side by side in an annular shape (that is, in a circumferential direction) at intervals. The respective teeth 101a form an annular teeth group. The stator core 101 further has an annular body 101b which integrally holds the respective teeth 101a from the outer circumferential side of the teeth group. The stator core 101 of this example is provided as a laminated body of a plate-like stator core plate which has an annular portion, and a plurality of teeth portions projecting from the inner circumferential side of the annular portion toward the center of the annular form and spaced apart from each other in the circumferential direction of the annular form. In the stator core 101, the laminated portion of the teeth portion forms, for example, rectangular teeth 101a, and the laminated portion of the annular portion forms a cylindrical annular body 101b.

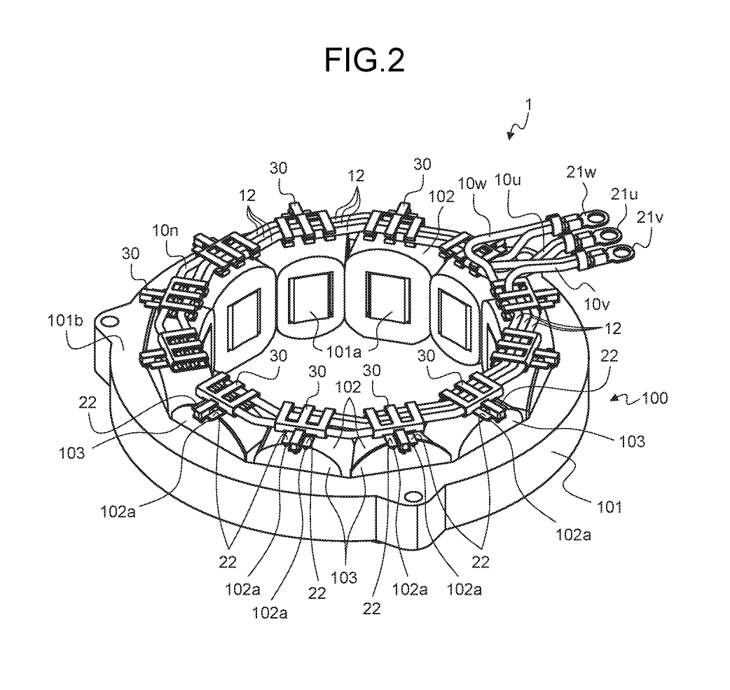

The stator 100 includes a plurality of stator coils 102 in which each conductive wire is wound around each of the teeth 101a. Each of the stator coils 102 is arranged side by side in an annular shape (that is, in the circumferential direction) in accordance with each of the teeth 101a to form an annular stator coil group. In the stator 100 of this example, a tubular coil insulator 103 is fitted to each of the teeth 101a, and wire materials are wound around the coil insulator 103, respectively, thereby forming the respective stator coils 102. Both ends of the stator coil 102 are drawn out at equivalent positions as lead wires 102a (FIGS. 1 and 2). As it will be described later, the power supply ring 1 is substantially concentrically laminated on the stator coil group. Each lead wire 102a is drawn out to a position on which the power supply ring 1 is laminated.

Here, the combinations of the teeth 101a, the stator coil 102, and the coil insulator 103 of each phase (here, three phases of a U-phase, a V-phase, and a W-phase) of the rotating machine of this example are disposed at four positions shifted from each other by 90 degrees.

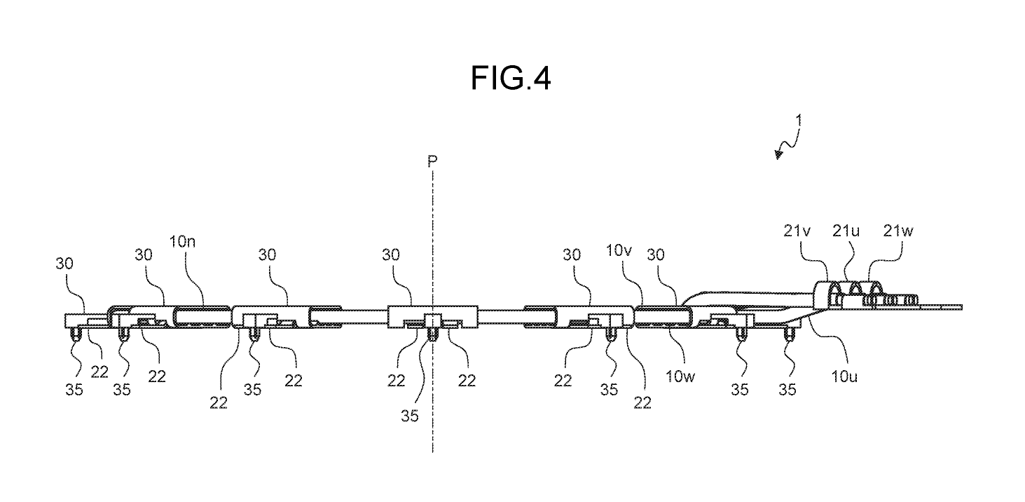

The power supply ring 1 is formed into an annular shape in conformity with the annular stator 100. Hereinafter, unless otherwise mentioned, a direction along an axis P (FIG. 4) of an annular center axis is referred to as an axial direction, a direction around the axis with the axis P as a center is referred to as a circumferential direction, and a direction orthogonal to the axis P is referred to as a radial direction.

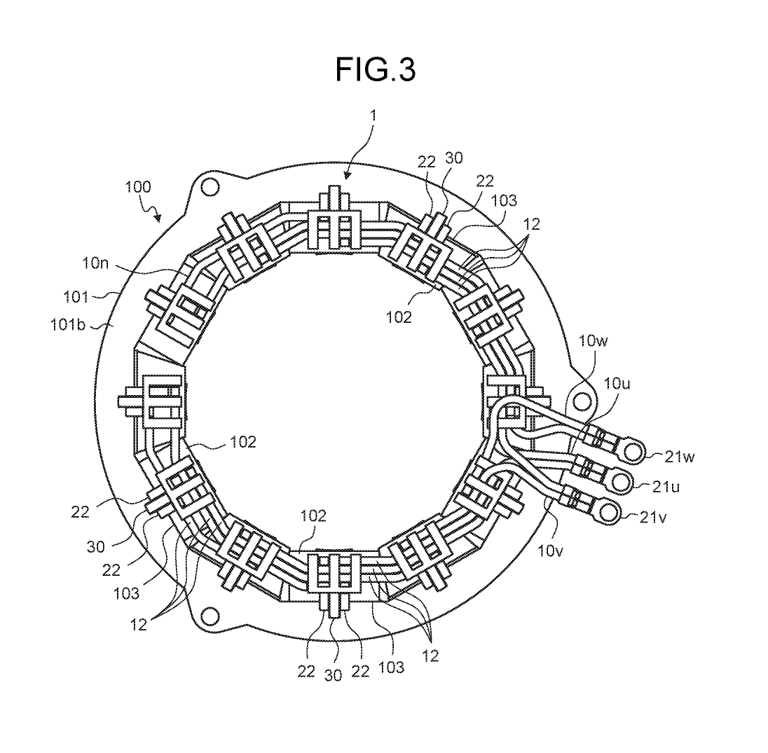

The power supply ring 1 includes conductors (hereinafter, referred to as “bus rings”) 10u, 10v, and 10w for each of the phases of the rotating machine (three phases of U-phase, V-phase and W-phase) extending in the circumferential direction along a plurality of stator coils 102 (an annular stator coil group), metallic power supply terminals 21u, 21v and 21w for each phase which electrically connect the bus rings 10u, 10v, and 10w to a power source side inverter (not illustrated), and a plurality of metallic coil connection terminals 22 which electrically connect the bus rings 10u, 10v, and 10w to each of the stator coils 102 of the same phase (FIG. 3).

Further, the power supply ring 1 of the present embodiment is also provided with a neutral-phase bus ring (hereinafter, referred to as “neutral-phase bus ring”) 10n. Like the bus rings 10u, 10v, and 10w, the neutral-phase bus ring 10n extends in the circumferential direction along a plurality of stator coils 102 (the annular stator coil group). In the power supply ring 1, like the bus rings 10u, 10v, and 10w, a plurality of coil connection terminals 22 is also connected to the neutral-phase bus ring 10n.

The bus rings 10u, 10v, and 10w of the respective phases of this example form a main body portion to have an annular ring shape or a Landolt ring shape extending in the circumferential direction on a concentric circle, respectively, and are disposed concentrically on the annular body made up of a plurality of stator coils 102 (an annular stator coil group). Meanwhile, the neutral-phase bus ring 10n forms a main body portion to have an arc shape extending in the circumferential direction, and is disposed concentrically on the annular body. Therefore, in the power supply ring 1, the bus rings 10u, 10v, and 10w of each phase and the neutral-phase bus ring 10n are concentrically disposed.

The bus rings 10u, 10v, and 10w of each phase and the neutral-phase bus ring 10n are concentrically arranged side by side. In the power supply ring 1, any arrangement may be adopted, but in order to suppress an increase in the body size in the axial direction, the bus rings 10u, 10v, and 10w of each phase and the neutral-phase bus ring 10n are concentrically arranged side by side in the radial direction (FIGS. 1 to 3), respectively. Therefore, in the power supply ring 1, since the bus rings 10u, 10v, and 10w and the neutral-phase bus ring 10n are disposed on the same plane, it is possible to suppress the increase in the body size in the axial direction. Therefore, in the power supply ring 1, it is possible to suppress an increase in the body size of the stator unit in the axial direction.

However, depending on the arrangement of the bus rings 10u, 10v, and 10w and the neutral-phase bus ring 10n with respect to the stator 100 (for example, when the bus rings are disposed radially outside with respect to the annular stator coil group), there is a risk of causing an increase in the body size of the stator unit in the radial direction. Therefore, the bus rings 10u, 10v, and 10w of each phase and the neutral-phase bus ring 10n are concentrically laminated on an annular body including a plurality of stator coils 102 (the annular stator coil group) in the axial direction. Therefore, in the power supply ring 1, regardless of the arrangement of the bus rings 10u, 10v, and 10w of each phase and the neutral-phase bus ring 10n, it is possible to suppress an increase in the body size of the stator unit in the radial direction. At the laminated position, it is desirable to dispose each of the bus rings 10u, 10v, and 10w and the neutral-phase bus ring 10n so that at least the main body portion is located between the outer wall surface side and the inner wall surface side of the annular body, when viewed in the axial direction. In the power supply ring 1, by disposing the bus rings 10u, 10v, and 10w and the neutral-phase bus ring 10n as described above, it is possible to further suppress an increase in the body size of the stator unit in the radial direction.

The bus rings 10u, 10v, and 10w and the neutral-phase bus ring 10n of this example are concentrically arranged side by side in the radial direction, respectively, and are laminated concentrically on the annular body of the stator coil 102 in the axial direction. Therefore, in the power supply ring 1, it is possible to suppress increases in the body size of the stator unit in the axial direction and the body size of the stator unit in the radial direction.

The power supply terminals 21u, 21v, and 21w of this example are prepared as crimping terminals crimped by caulking or the like, and are crimped to the respective connecting positions 11a of the bus rings 10u, 10v, and 10w which are connecting targets. The bus rings 10u, 10v, and 10w of this example are provided with connecting positions 11a on the same plane as the main body portion extending in the circumferential direction so as to suppress the increase in the body size in the axial direction. Here, the connecting position 11a is made to protrude radially outward on the same plane. Further, the power supply terminals 21u, 21v, and 21w of this example are disposed so that the longitudinal direction thereof extends along a plane orthogonal to the axis P, and are crimped to the connecting position 11a. Therefore, in the power supply ring 1, since the respective power supply terminals 21u, 21v, and 21w are disposed on the same plane as the bus rings 10u, 10v, and 10w of the respective phases, it is possible to suppress the increase in the body size in the axial direction. Therefore, in the power supply ring 1, it is possible to suppress an increase in the body size of the stator unit in the axial direction.

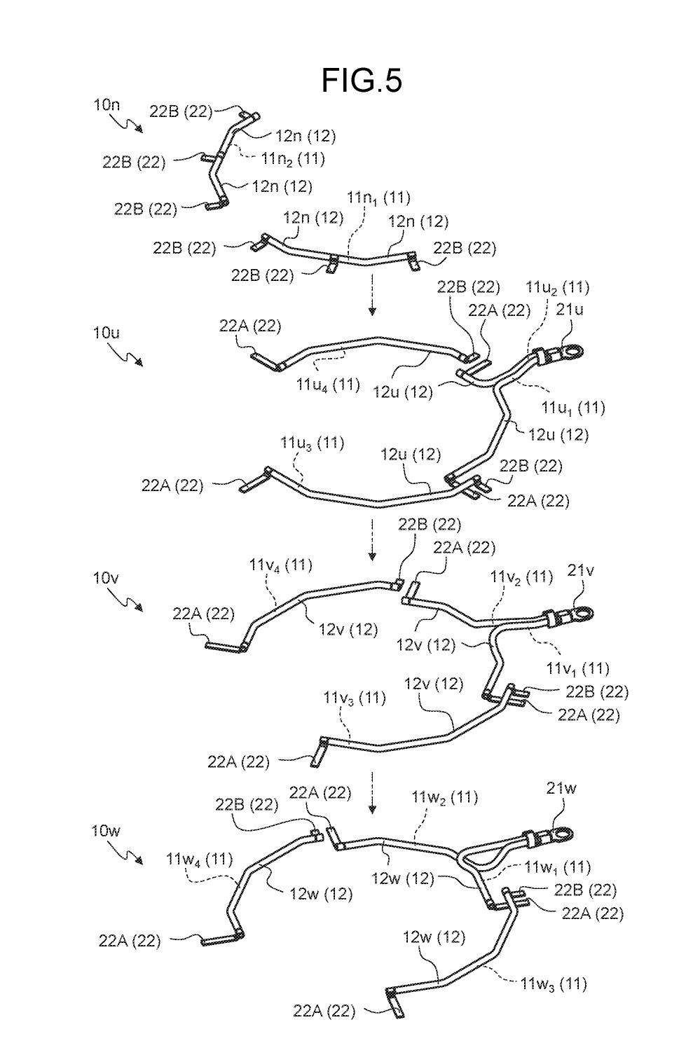

The coil connection terminals 22 of the bus rings 10u, 10v, and 10w of the respective phases electrically connect the bus rings 10u, 10v, and 10w to the stator coils 102 of the same phase. In this example, as the coil connection terminal 22, a first coil connection terminal 22A and a second coil connection terminal 22B are provided (FIGS. 5 to 8). The first coil connection terminal 22A is interposed between the bus rings 10u, 10v, and 10w of the same phase and the lead wire 102a at one end of the stator coil 102 to electrically connect the bus rings and the lead wire, and the second coil connection terminal 22B is interposed between the bus rings 10u, 10v, and 10w of the same phase and the lead wire 102a at the other end of the stator coil 102 to electrically connect the bus rings and the lead wire.

The coil connection terminal 22 of the neutral-phase bus ring 10n electrically connects the bus rings 10u, 10v, and 10w of each phase via the stator coil 102 of the same phase. In this example, a second coil connection terminal 22B is provided as the coil connection terminal 22 (FIGS. 5 and 9). The second coil connection terminal 22B of the neutral-phase bus ring 10n is electrically connected to the lead wire 102a of the other end of the stator coils 102 of each of the U-phase, V-phase and W-phase to which only the first coil connection terminals 22A of the bus rings 10u, 10v, and 10w are connected.

Like the power supply terminals 21u, 21v, and 21w, the coil connection terminals 22 (the first coil connection terminals 22A and the second coil connection terminals 22B) of this example are disposed so that the longitudinal direction thereof extends along a plane orthogonal to the axis P, and are crimped to the connecting positions 11b of each of the bus rings 10u, 10v, and 10w and the neutral-phase bus ring 10n as the connecting targets by caulking or the like. The connecting position 11b is provided in the main body portions of the bus rings 10u, 10v, and 10w and the neutral-phase bus ring 10n. Therefore, in the power supply ring 1, the respective coil connection terminals 22 (the first coil connection terminals 22A and the second coil connection terminals 22B) are disposed on the same plane as the bus rings 10u, 10v, and 10w of each phase and the neutral-phase bus ring 10n. Thus, from this point, it is also possible to suppress an increase in body size in the axial direction. Therefore, in the power supply ring 1, it is possible to suppress an increase in the body size of the stator unit in the axial direction.

Specifically, the first coil connection terminal 22A and the second coil connection terminal 22B of this example are made of a metallic plate material. The first coil connection terminal 22A and the second coil connection terminal 22B form connecting units to the bus rings 10u, 10v, and 10w and the neutral-phase bus ring 10n in the same shape. The connecting unit is crimped so as to cover the outer peripheral surface of the connecting position 11b of the bus rings 10u, 10v, and 10w and the neutral-phase bus ring 10n. The first coil connection terminal 22A and the second coil connection terminal 22B have a piece extending from the connecting unit to the connecting position with the stator coil 102. Here, the connecting position 11b to which the first coil connection terminal 22A is crimped is disposed on the radially inner side than the connecting position 11b to which the second coil connection terminal 22B is crimped. Therefore, the first coil connection terminal 22A has a longer piece than the second coil connection terminal 22B. The piece of the coil connection terminal 22 (the first coil connection terminal 22A and the second coil connection terminal 22B) is connected to the lead wire 102a of the stator coil 102 by welding. In this example, the piece is placed on the lead wire 102a, and the piece and the lead wire 102a are connected by ultrasonic welding. Further, the connection therebetween may be performed by crimping such as caulking, and the coil connection terminals 22 may be formed in a shape corresponding to the connection form.

Hereinafter, the configurations of the bus rings 10u, 10v, and 10w and the neutral-phase bus ring 10n will be described, and a specific example of the power supply ring 1 will be illustrated.

Each of the bus rings 10u, 10v, and 10w includes a conductive member 11 extending in the circumferential direction along an annular stator coil group, and an insulating coating 12 which covers the conductive member 11 (FIGS. 5 to 8). A plurality of conductive members 11 is used in each of the bus rings 10u, 10v, and 10w. In each of the bus rings 10u, 10v, and 10w, the conductive members 11 thereof are arranged side by side along the circumferential direction of the annular stator coil group, and the adjacent conductive members 11 are electrically connected to each other via the stator coil 102. The coating 12 is provided in the portions of the conductive members 11 of the bus rings 10u, 10v, and 10w, except for the connecting position 11a with the power supply terminals 21u, 21v, and 21w and the connecting position 11b with the coil connection terminals 22.

Further, similarly to the bus rings 10u, 10v, and 10w, the neutral-phase bus ring 10n includes a conductive member 11 extending in the circumferential direction along an annular stator coil group, and an insulating coating 12 which covers the conductive member 11 (FIGS. 5 and 9). In the neutral-phase bus ring 10n, two conductive members 11 are used. In the neutral-phase bus ring 10n, the conductive members 11 are arranged side by side along the circumferential direction of the annular stator coil group. The coating 12 is provided in the portion of the conductive member 11 of the neutral-phase bus ring 10n, except for the connecting position 11b with the coil connection terminal 22.

As the conductive member 11, it is conceivable to use a member molded by bending a single metallic rod or a member molded by bending a bundle of a plurality of metallic strands. In the present embodiment, the latter bundle of the strands having flexibility is used to improve the assembling workability to the stator 100.

Here, the power supply ring 1 enters the lubricating oil of the rotating machine. Therefore, as the material of the coating 12, a material having insulation properties and oil resistance (synthetic resin or the like) is used. It is desirable that the coating 12 be made flexible so as not to hinder the flexibility of the conductive member 11. As a result, the power supply ring 1 of the present embodiment has high follow-up performance with respect to the shape of the stator 100, and it is possible to improve the assembling workability to the stator 100. In addition, due to its flexibility, the power supply ring 1 can absorb vibration against an input from the outside.

For example, as the coating 12, it is conceivable to adopt coating in which a portion except the connecting positions 11a and 11b is removed from the insulating coating (for example, a fluororesin coating) for covering the entire outer peripheral surface of the conductive member 11, coating such as a heat shrinkable tube attached except the connecting positions 11a and 11b, and the like. Further, an ultraviolet cured coating made of an ultraviolet curable resin may be applied to the coating 12. In this case, the ultraviolet curable resin is applied so as to cover the entire outer peripheral surface of the conductive member 11, and the portion of the ultraviolet curable resin except the connecting positions 11a and 11b is irradiated with the ultraviolet rays. As a result, the coating (ultraviolet cured coating) 12 made of an ultraviolet curable resin is formed in a portion except the connecting positions 11a and 11b of the conductive member 11. In this example, the ultraviolet cured coating is used. As a result, the coating (ultraviolet cured coating) 12 can be made thinner than other forms (for example, fluororesin coating), while ensuring the insulation properties and the oil resistance. Accordingly, it is possible to suppress an increase in body size of the bus rings 10u, 10v, and 10w and the neutral-phase bus ring 10n in the axial direction and in the radial direction. Therefore, in the power supply ring 1, it is possible to suppress an increase in the body size of the stator unit in the axial direction and in the radial direction.

The bus rings 10u, 10v, and 10w of the respective phases include, as the conductive member 11, a power supply side conductive member to which the power supply terminals 21u, 21v, and 21w of the same phase are connected, and at least one coupling conductive member arranged side by side in the circumferential direction with respect to the power supply side conductive member. The power supply side conductive member has an electrical connecting position 11a with the power supply terminals 21u, 21v, and 21w of the same phase provided at one end thereof, and an electrical connecting position 11b with the first coil connection terminal 22A provided at the other end thereof. Further, the coupling conductive member has electrical connecting positions 11b with the second coil connection terminals 22B provided at both ends thereof.

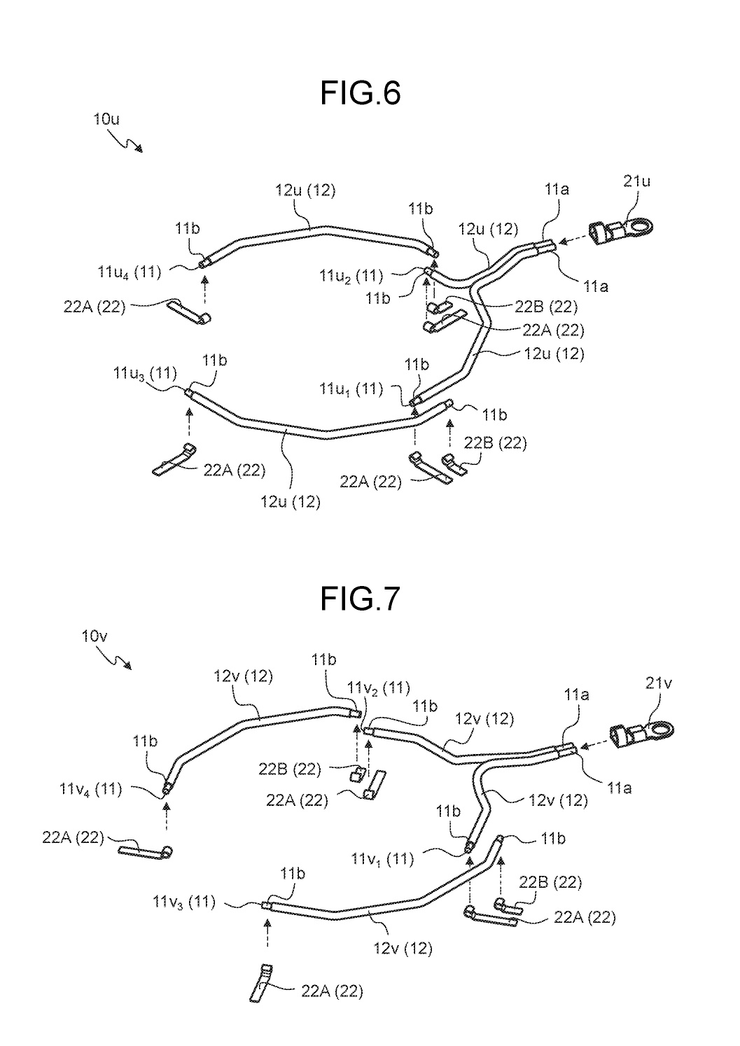

As illustrated in FIGS. 5 and 6, the U-phase bus ring 10u has a first conductive member 11u₁ and a second conductive member 11u₂ as the power supply side conductive members. The first conductive member 11u₁ extends along one circumferential direction with respect to the position of the power supply terminal 21u of the same phase. The second conductive member 11u₂ extends along the other circumferential direction with respect to the position of the power supply terminal 21u. Each of the first conductive member 11u₁ and the second conductive member 11u₂ has a connecting position 11a with the power supply terminal 21u of the same phase at one end, and a connecting position 11b with the first coil connection terminal 22A at the other end. In the first conductive member 11u₁ and the second conductive member 11u₂, a coating 12u is provided at a location except the connecting positions 11a and 11b of both ends thereof.

The connecting positions 11a of each of the first conductive member 11u₁ and the second conductive member 11u₂ are adjacent to each other in a state of making the axial directions match each other, and extend toward the outer side of a circular ring shape in the radial direction. The first conductive member 11u₁ and the second conductive member 11u₂ are integrated by crimping a single power supply terminal 21u to each connecting position 11a by caulking or the like. Meanwhile, the connecting positions 11b of each of the first conductive member 11u₁ and the second conductive member 11u₂ are disposed in the vicinity of the adjacent separate U-phase stator coil 102, respectively. In this example, the connecting position 11b and the first coil connection terminal 22A are laminated on the stator coil 102 in the axial direction, and the lead wire 102a at one end of the stator coil 102 and the first coil connection terminal 22A are electrically connected to each other.

Furthermore, the bus ring 10u has a third conductive member 11u₃ and a fourth conductive member 11u₄ as the coupling conductive members. The third conductive member 11u₃ is arranged in parallel to the first conductive member 11u₁ along the one circumferential direction. The fourth conductive member 11u₄ is arranged in parallel to the second conductive member 11u₂ along the other circumferential direction. The third conductive member 11u₃ and the fourth conductive member 11u₄ electrically connect the U-phase stator coil 102 which is adjacent in the circumferential direction. Therefore, in the bus ring 10u, at least one third conductive member 11u₃ and at least one fourth conductive member 11u₄ are provided in accordance with the number of poles. Both ends of each of the third conductive member 11u₃ and the fourth conductive member 11u₄ are the connecting positions 11b with the coil connection terminal 22. In the third conductive member 11u₃ and the fourth conductive member 11u₄, coatings 12u are provided at a place except the connecting positions 11b at both ends thereof.

The bus ring 10u is provided with a single third conductive member 11u₃ and a single fourth conductive member 11u₄. In the bus ring 10u, the first conductive member 11u₁ and the third conductive member 11u₃ are connected to each other, and the second conductive member 11u₂ and the fourth conductive member 11u₄ are connected to each other.

The connecting position 11b at one end of the third conductive member 11u₃ and the second coil connection terminal 22B are axially laminated on the U-phase stator coil 102, to which the first coil connection terminal 22A at the other end of the first conductive member 11u₁ is connected. Further, the second coil connection terminal 22B is electrically connected to the lead wire 102a at the other end of the stator coil 102. In other words, the first coil connection terminal 22A and the second coil connection terminal 22B of the first conductive member 11u₁ and the third conductive member 11u₃ are electrically connected to the common U-phase stator coil 102.

In contrast, the connecting position 11b at the other end of the third conductive member 11u₃ and the first coil connection terminal 22A are axially laminated on the stator coil 102 of the same phase which is adjacent to the U-phase stator coil 102 on the one circumferential direction side. Further, the first coil connection terminal 22A is electrically connected to the lead wire 102a at one end of the stator coil 102.

The connecting position 11b at one end of the fourth conductive member 11u₄ and the second coil connection terminal 22B are axially laminated on the U-phase stator coil 102, to which the first coil connection terminal 22A at the other end of the second conductive member 11u₂ is connected. Further, the second coil connection terminal 22B is electrically connected to the lead wire 102a at the other end of the stator coil 102. In other words, the first coil connection terminal 22A and the second coil connection terminal 22B of the second conductive member 11u₂ and the fourth conductive member 11u₄ are electrically connected to the common U-phase stator coil 102.

In contrast, the connecting position 11b at the other end of the fourth conductive member 11u₄ and the first coil connection terminal 22A are axially laminated on the stator coil 102 of the same phase which is adjacent to the U-phase stator coil 102 on the other circumferential direction side. Further, the first coil connection terminal 22A is electrically connected to the lead wire 102a at one end of the stator coil 102.

As illustrated in FIGS. 5 and 7, the V-phase bus ring 10v has a first conductive member 11v₁ and a second conductive member 11v₂ as the power supply side conductive members. The first conductive member 11v₁ extends along one circumferential direction with respect to the position of the power supply terminal 21v of the same phase. The second conductive member 11v₂ extends along the other circumferential direction with respect to the position of the power supply terminal 21v. Each of the first conductive member 11v₁ and the second conductive member 11v₂ has a connecting position 11a with the power supply terminal 21v of the same phase at one end, and a connecting position 11b with the first coil connection terminal 22A at the other end. In the first conductive member 11v₁ and the second conductive member 11v₂, coatings 12v are provided at the positions except the connecting positions 11a and 11b at both ends thereof.

The connecting positions 11a of each of the first conductive member 11v₁ and the second conductive member 11v₂ are adjacent to each other in a state of making the axial directions thereof match each other, and extend toward the outer side of the circular ring shape in the radial direction. The first conductive member 11v₁ and the second conductive member 11v₂ are integrated by crimping a single power supply terminal 21v to each connecting position 11a by caulking or the like. Meanwhile, the connecting positions 11b of each of the first conductive member 11v₁ and the second conductive member 11v₂ are disposed in the vicinity of the adjacent separate V-phase stator coil 102. In this example, the connecting position 11b and the first coil connection terminal 22A are laminated on the stator coil 102 in the axial direction, and the lead wire 102a at one end of the stator coil 102 and the first coil connection terminal 22A are electrically connected to each other.

Further, the bus ring 10v has a third conductive member 11v₃ and a fourth conductive member 11v₄ as the coupling conductive members. The third conductive member 11v₃ is arranged in parallel to the first conductive member 11v₁ along the one circumferential direction. The fourth conductive member 11v₄ is arranged in parallel to the second conductive member 11v₂ along the other circumferential direction. The third conductive member 11v₃ and the fourth conductive member 11v₄ electrically connect the V-phase stator coils 102 that are adjacent to each other in the circumferential direction. Therefore, in the bus ring 10v, at least one third conductive member 11v₃ and at least one fourth conductive member 11v₄ are provided in accordance with the number of poles. Both ends of each of the third conductive member 11v₃ and the fourth conductive member 11v₄ are the connecting positions 11b with the coil connection terminal 22. In the third conductive member 11v₃ and the fourth conductive member 11v₄, the coatings 12v are provided at the place except the connecting positions 11b at both ends thereof.

The bus ring 10v includes a single third conductive member 11v₃ and a single fourth conductive member 11v₄. In the bus ring 10v, the first conductive member 11v₁ and the third conductive member 11v₃ are connected to each other, and the second conductive member 11v₂ and the fourth conductive member 11v₄ are connected to each other.

The connecting position 11b at one end of the third conductive member 11v₃ and the second coil connection terminal 22B are axially laminated on the V-phase stator coil 102 to which the first coil connection terminal 22A at the other end of the first conductive member 11v₁ is connected. Further, the second coil connection terminal 22B is electrically connected to the lead wire 102a at the other end of the stator coil 102. That is, the first coil connection terminal 22A and the second coil connection terminal 22B of the first conductive member 11v₁ and the third conductive member 11v₃ are electrically connected to the common V-phase stator coil 102.

In contrast, the connecting position 11b at the other end of the third conductive member 11v₃ and the first coil connection terminal 22A are axially laminated on the stator coil 102 of the same phase which is adjacent to the V-phase stator coil 102 on the one circumferential direction side. Further, the first coil connection terminal 22A is electrically connected to the lead wire 102a at one end of the stator coil 102.

The connecting position 11b at one end of the fourth conductive member 11v₄ and the second coil connection terminal 22B are axially laminated on the V-phase stator coil 102, to which the first coil connection terminal 22A at the other end of the second conductive member 11v₂ is connected. Further, the second coil connection terminal 22B is electrically connected to the lead wire 102a at the other end of the stator coil 102. In other words, the first coil connection terminal 22A and the second coil connection terminal 22B of the second conductive member 11v₂ and the fourth conductive member 11v₄ are electrically connected to the common V-phase stator coil 102.

In contrast, the connecting position 11b at the other end of the fourth conductive member 11v₄ and the first coil connection terminal 22A are axially laminated on the stator coil 102 of the same phase which is adjacent to the V-phase stator coil 102 on the other circumferential direction side. Further, the first coil connection terminal 22A is electrically connected to the lead wire 102a at one end of the stator coil 102.

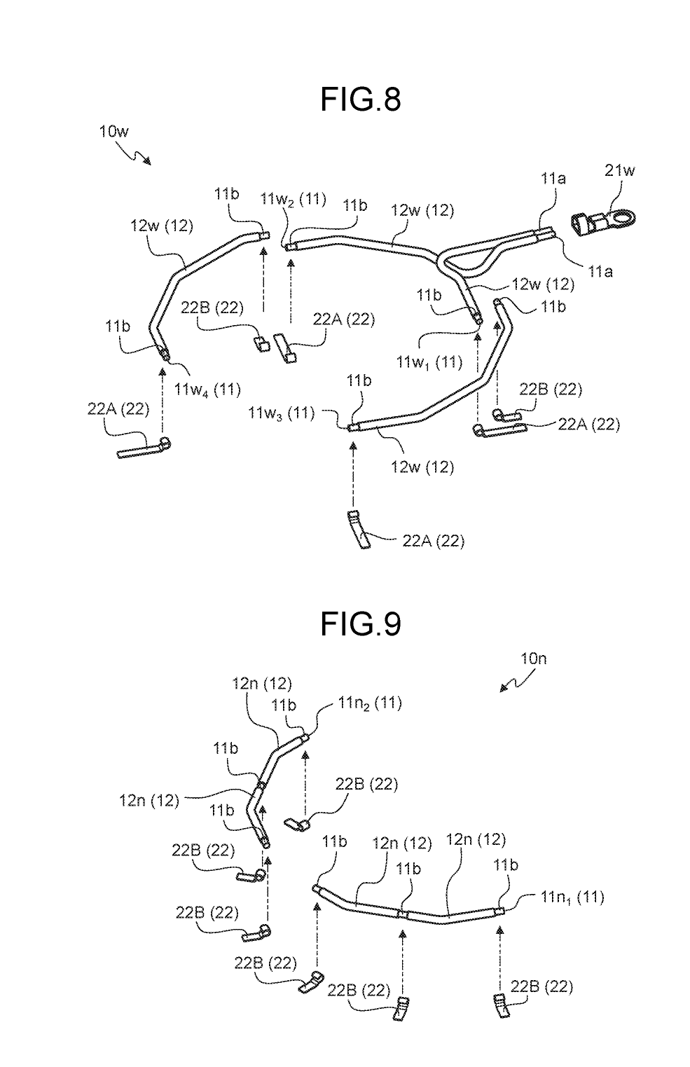

As illustrated in FIGS. 5 and 8, the W-phase bus ring 10w has a first conductive member 11w₁ and a second conductive member 11w₂ as the power supply side conductive members. The first conductive member 11w₁ extends along one circumferential direction with respect to the position of the power supply terminal 21w of the same phase. The second conductive member 11w₂ extends along the other circumferential direction with respect to the position of the power supply terminal 21w. Each of the first conductive member 11w₁ and the second conductive member 11w₂ has a connecting position 11a with the power supply terminal 21w of the same phase at one end, and a connecting position 11b with the first coil connection terminal 22A at the other end. In the first conductive member 11w₁ and the second conductive member 11w₂, coatings 12w are provided at the places except the connecting positions 11a and 11b at both ends thereof.

The connecting positions 11a of each of the first conductive member 11w₁ and the second conductive member 11w₂ are adjacent to each other in a state of making the axial directions thereof match each other, and extend toward the outer side of the circular ring shape in the radial direction. The first conductive member 11w₁ and the second conductive member 11w₂ are integrated by crimping a single power supply terminal 21w to each connecting position 11a by caulking or the like. Meanwhile, the connecting positions 11b of each of the first conductive member 11w₁ and the second conductive member 11w₂ are disposed in the vicinity of the adjacent separate W-phase stator coil 102. In this example, the connecting position 11b and the first coil connection terminal 22A are laminated on the stator coil 102 in the axial direction, and the lead wire 102a at one end of the stator coil 102 and the first coil connection terminal 22A are electrically connected to each other.

Furthermore, the bus ring 10w has a third conductive member 11w₃ and a fourth conductive member 11w₄ as the coupling conductive members. The third conductive member 11w₃ is arranged in parallel to the first conductive member 11w₁ along the one circumferential direction. The fourth conductive member 11w₄ is arranged in parallel to the second conductive member 11w₂ along the other circumferential direction. The third conductive member 11w₃ and the fourth conductive member 11w₄ electrically connect the W-phase stator coils 102 that are adjacent to each other in the circumferential direction. Therefore, in the bus ring 10w, at least one third conductive member 11w₃ and at least one fourth conductive member 11w₄ are provided in accordance with the number of poles. Both ends of each of the third conductive member 11w₃ and the fourth conductive member 11w₄ are the connecting positions 11b with the coil connection terminal 22. In the third conductive member 11w₃ and the fourth conductive member 11w₄, coatings 12w are provided at the places except the connecting positions 11b at both ends thereof.

The bus ring 10w includes a single third conductive member 11w₃ and a single fourth conductive member 11w₄. In the bus ring 10w, the first conductive member 11w₁ and the third conductive member 11w₃ are connected to each other, and the second conductive member 11w₂ and the fourth conductive member 11w₄ are connected to each other.

The connecting position 11b at one end of the third conductive member 11w₃ and the second coil connection terminal 22B are axially laminated on the W-phase stator coil 102 to which the first coil connection terminal 22A at the other end of the first conductive member 11w₁ is connected. Further, the second coil connection terminal 22B is electrically connected to the lead wire 102a at the other end of the stator coil 102. That is, the first coil connection terminal 22A and the second coil connection terminal 22B of the first conductive member 11w₁ and the third conductive member 11w₃ are electrically connected to the common W-phase stator coil 102.

In contrast, the connecting position 11b at the other end of the third conductive member 11w₃ and the first coil connection terminal 22A are axially laminated on the stator coil 102 of the same phase which is adjacent to the W-phase stator coil 102 on the one circumferential direction side. Further, the first coil connection terminal 22A is electrically connected to the lead wire 102a at one end of the stator coil 102.

The connecting position 11b at one end of the fourth conductive member 11w₄ and the second coil connection terminal 22B are axially laminated on the W-phase stator coil 102, to which the first coil connection terminal 22A at the other end of the second conductive member 11w₂ is connected. Further, the second coil connection terminal 22B is electrically connected to the lead wire 102a at the other end of the stator coil 102. In other words, the first coil connection terminal 22A and the second coil connection terminal 22B of the second conductive member 11w₂ and the fourth conductive member 11w₄ are electrically connected to the common W-phase stator coil 102.

In contrast, the connecting position 11b at the other end of the fourth conductive member 11w₄ and the first coil connection terminal 22A are axially laminated on the stator coil 102 of the same phase which is adjacent to the W-phase stator coil 102 on the other circumferential direction side. Further, the first coil connection terminal 22A is electrically connected to the lead wire 102a at one end of the stator coil 102.

As illustrated in FIGS. 5 and 9, the neutral-phase bus ring 10n has a first conductive member 11n₂ and a second conductive member 11n₂ that are arranged side by side in the circumferential direction.

The first conductive member 11n₁ is electrically connected to the lead wire 102a at the other end of the U-phase stator coil 102 (to which the first coil connection terminal 22A of the U-phase third conductive member 11u₃ is connected), the lead wire 102a at the other end of the V-phase stator coil 102 (to which the first coil connection terminal 22A of the V-phase third conductive member 11v₃ is connected), and the lead wire 102a at the other end of the W-phase stator coil 102 (to which the first coil connection terminal 22A of the W-phase third conductive member 11w₃ is connected). For this reason, the first conductive member 11n₁ has the connecting positions 11b with the second coil connection terminal 22B provided at both ends and the middle thereof, and the coating 12n is provided at a place except the three connecting positions 11b. The first conductive member 11n₁ laminates the respective connecting positions 11b and the second coil connection terminals 22B with respect to the stator coils 102 of the respective phases in the axial direction.

The second conductive member 11n₂ is electrically connected to the lead wire 102a at the other end of the U-phase stator coil 102 (to which the first coil connection terminal 22A of the U-phase fourth conductive member 11u₄ is connected), the lead wire 102a at the other end of the V-phase stator coil 102 (to which the first coil connection terminal 22A of the V-phase fourth conductive member 11v₄ is connected), and the lead wire 102a at the other end of the W-phase stator coil 102 (to which the first coil connection terminal 22A of the W-phase fourth conductive member 11w₄ is connected). For this reason, the second conductive member 11n₂ has the connecting positions 11b with the second coil connection terminal 22B provided at both ends and the middle thereof, and the coating 12n is provided at a place except the three connecting positions 11b. The second conductive member 11n₂ laminates the respective connecting positions 11b and the second coil connection terminals 22B with respect to the stator coils 102 of the respective phases in the axial direction.

In the power supply ring 1, the bus rings 10u, 10v, and 10w of each phase and the neutral-phase bus ring 10n thus formed are concentrically arranged on the same plane side by side in a radial direction, and the bus rings are bundled together. The power supply ring 1 is provided with a holding member 30 that performs such holding (FIGS. 1 to 4 and 10). The holding member 30 is formed of an insulating material such as synthetic resin, and a plurality of holding members 30 is arranged at intervals in the circumferential direction.

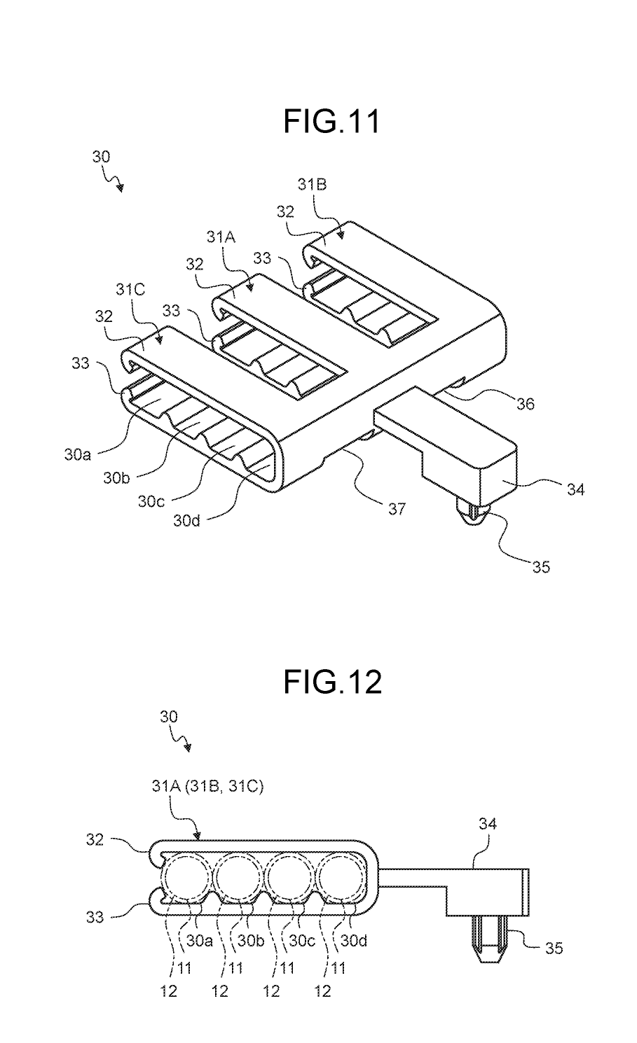

The holding member 30 of this example has first to third holding bodies 31A, 31B, and 31C (FIGS. 11 to 13). The first to third holding bodies 31A, 31B and 31C are coupled to be spaced apart from each other in a tangential direction of the annular bus rings 10u, 10v, and 10w and the neutral-phase bus ring 10n. The first to third holding bodies 31A, 31B, and 31C have two pieces 32 and 33 disposed along a plane orthogonal to the axis P and spaced apart from each other, and hold the conductive members 11 of the bus rings 10u, 10v, and 10w and the neutral-phase bus ring 10n, while holding the bus rings with the two pieces 32 and 33 from above the coating 12. The first to third holding bodies 31A, 31B, and 31C are capable of holding a maximum of the four conductive members 11 covered with the coating 12. Thus, the four holding units 30a, 30b, 30c, and 30d are formed in the space between the two pieces 32 and 33. The holding member 30 holds the bus rings 10u, 10v, and 10w and the neutral-phase bus ring 10n so that the holding unit 30a is disposed on the inner side in the radial direction and the holding unit 30d is disposed on the outer side in the radial direction. Between the two pieces 32 and 33, the holding unit 30a side on the inner side in the radial direction is an opening. In the holding member 30, the bus rings 10u, 10v, and 10w and the neutral-phase bus ring 10n are inserted into the holding units 30a, 30b, 30c, and 30d from the opening. The first to third holding bodies 31A, 31B, and 31C have elasticity so that the gap between the two pieces 32 and 33 can be expanded with the opposite side of the opening as a fulcrum, upon insertion of the bus rings 10u, 10v, and 10w and the neutral-phase bus ring 10n. Either one of the inserted bus rings 10u, 10v, or 10w of each phase is held in each of the holding units 30a, 30b, 30c, and 30d. In the holding member 30 which holds the neutral-phase bus ring 10n, the neutral-phase bus ring 10n is held by the holding unit 30d.

The holding member 30 has an extension portion 34 extending radially outward from the opposite side of the openings of the first to third holding bodies 31A, 31B, and 31C, and an engaging portion 35 is provided in the extension portion 34, (FIGS. 1, 11, and 12). Meanwhile, the stator 100 is provided with a portion 103a to be engaged (FIG. 1). By engaging the engaging portion 35 of the holding member 30 with the portion 103a to be engaged, it is possible to position the power supply ring 1 with respect to the stator 100, and it is possible to fix the power supply ring 1 to the stator 100. For example, one of the engaging portion 35 and the portion 103a to be engaged is a through-hole, and the other thereof is a protrusion fitted to the through-hole. In this example, the engaging portion 35 as a protrusion is formed in the extension portion 34, and the portion 103a to be engaged as a through-hole is provided in the stator 100.

Here, the respective holding members 30 are provided for each stator coil 102, and are laminated on the respective stator coils 102 in the axial direction. Therefore, the portion 103a to be engaged of this example is provided in the coil insulator 103 of the stator coil 102. For example, the portion 103a to be engaged is formed in a piece extending radially outward from the coil insulator 103. The engaging portion 35 is inserted into the portion 103a to be engaged, together with the axial movement in which the power supply ring 1 is placed on the annular body including the plurality of stator coils 102 (the annular stator coil group). Therefore, the engaging portion 35 of this example protrudes toward the moving direction of the power supply ring 1 at the time of placement.

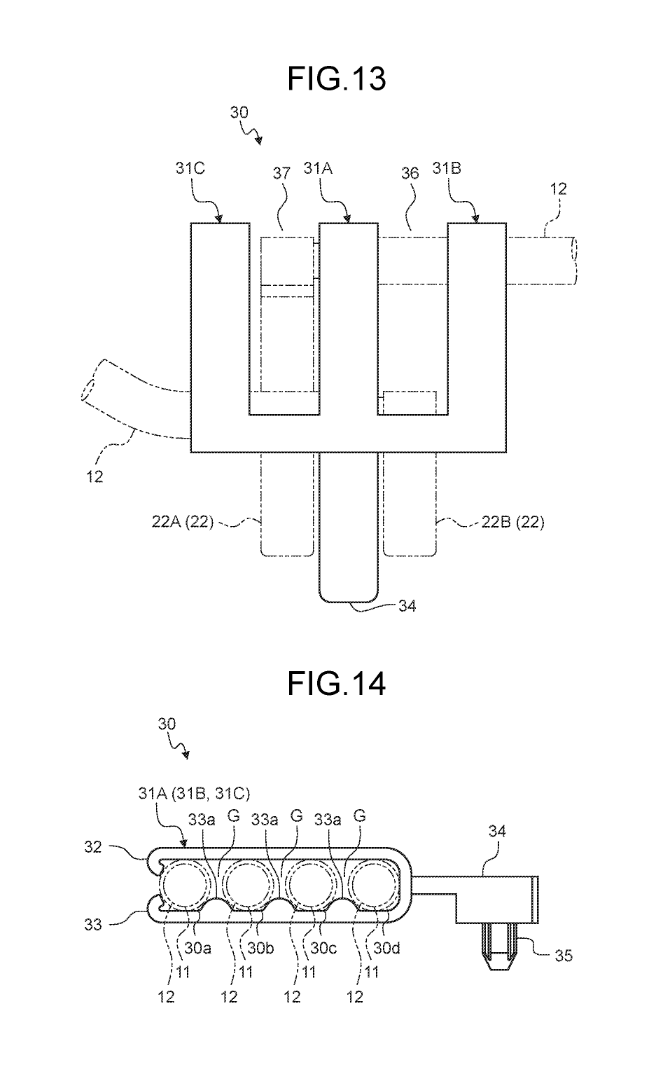

Further, since the respective holding members 30 are laminated on the respective stator coils 102 in the axial direction, the holding members 30 are disposed near the coil connection terminals 22 (the first coil connection terminals 22A and the second coil connection terminals 22B) connected to the corresponding stator coils 102. In the holding member 30, the second coil connection terminal 22B is disposed in a gap 36 between the first holding body 31A and the second holding body 31B, and the first coil connection terminal 22A is disposed in a gap 37 between the first holding body 31A and the third holding body 31C (FIG. 13).

Each holding member 30 can suppress a change in the relative position of the bus rings 10u, 10v, and 10w and the neutral-phase bus ring 10n with respect to the stator 100. Therefore, in the power supply ring 1, it is possible to suppress an increase in the body size of the stator unit in the axial direction and in the radial direction.

As described above, in the power supply ring 1 of the present embodiment, the bus rings 10u, 10v, and 10w of each phase and the neutral-phase bus ring 10n are concentrically laminated on the annular body including a plurality of stator coils 102 (the annular stator coil group) in the axial direction. Therefore, when the power supply ring 1 is attached to the stator 100, it is possible to suppress an increase in the body size of the stator unit in the radial direction. By disposing the power supply ring 1 so that the bus rings 10u, 10v, and 10w and the neutral-phase bus ring 10n are placed between the outer wall surface side and the inner wall surface side of the annular body when viewed in the axial direction, it is possible to further suppress an increase in the body size of the stator unit in the radial direction.

Furthermore, since the bus rings 10u, 10v, and 10w of each phase and the neutral-phase bus ring 10n are concentrically arranged side by side in the radial direction in the power supply ring 1, when attached to the stator 100, it is possible to suppress an increase in the body size of the stator unit in the axial direction and in the radial direction.

Furthermore, in the power supply ring 1, the bus rings 10u, 10v, and 10w and the neutral-phase bus ring 10n are provided with connecting positions 11a and 11b on the same plane as the main body portion extending in the circumferential direction. Further, in the power supply ring 1, the power supply terminals 21u, 21v, and 21w and the coil connection terminals 22 (the first coil connection terminals 22A and the second coil connection terminals 22B) are disposed such that the longitudinal direction extends along a plane orthogonal to the axis P. From this fact, it is also possible to suppress an increase in the body size of the stator unit in the axial direction in the power supply ring 1.

Furthermore, in the power supply ring 1, since the holding member 30 can suppress a change in the relative position of the bus rings 10u, 10v, and 10w and the neutral-phase bus ring 10n with respect to the stator 100, from this fact, it is possible to suppress an increase in body size of the stator unit in the axial direction and in the radial direction.

Furthermore, since the power supply ring 1 uses an ultraviolet cured coating as the coating 12, the wire diameters of the bus rings 10u, 10v, and 10w and the neutral-phase bus ring 10n can be made thin. In the power supply ring 1, from that fact, it is also possible to suppress an increase in the body size of the stator unit in the axial direction and in the radial direction.

In the stator unit illustrated here, since the power supply ring 1 is laminated on the annular body of the stator coil group, there is a risk of a decrease in the supply amount of the lubricating oil to the stator coil 102 by the power supply ring 1, leading to degradation of the cooling performance of the stator coil 102. Therefore, it is desirable that the bus rings 10u, 10v, and 10w and the neutral-phase bus ring 10n be bundled and held together in a state of being spaced apart from each other in the radial direction. In the power supply ring 1, the holding member 30 is formed as follows so that the bus rings 10u, 10v, and 10w and the neutral-phase bus ring 10n are held. For example, in the first to third holding bodies 31A, 31B, and 31C, on the surface of one (here, the piece 33) of the two pieces 32 and 33 facing the other (here, the piece 32), three protrusions 33a protruding toward the other piece (the piece 32) are formed (FIG. 14). Each protrusion 33a locks the bus rings 10u, 10v, and 10w and the neutral-phase bus ring 10n inserted into the holding units 30a, 30b, 30c, and 30d at their positions, and each protrusion 33a is formed so that a gap in the radial direction is provided between the adjacent bus rings among the bus rings 10u, 10v, and 10w and the neutral-phase bus ring 10n. The gap is set to a size within a range which enables the lubricating oil to reach the stator coil 102. The protrusion 33a is set to a protrusion amount within a range in which the insertion of the bus rings 10u, 10v, and 10w and the neutral-phase bus ring 10n into the holding units 30a, 30b, 30c, and 30d is not hindered. In this way, in the stator unit of this example, since the lubricating oil can flow from the gap G between the bus rings 10u, 10v, and 10w and the neutral-phase bus ring 10n to the respective stator coils 102, it is possible to suppress the degradation of the cooling performance of the stator coil 102. Therefore, in the power supply ring 1 of the present embodiment, it is possible to suppress an increase in the body size of the stator unit in the axial direction and in the radial direction, while suppressing the degradation of the cooling performance of the stator coil 102.

In the power supply ring according to the present embodiment, since the respective bus rings are concentrically laminated on the annular body made up of a plurality of stator coils in the axial direction, when attached to the stator, it is possible to suppress an increase in the body size of the stator unit in the radial direction.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power supply ring comprising:
a bus ring which is provided for each phase of a rotating machine having a plurality of stator coils arranged side by side in an annular shape and extends in a circumferential direction to extend along the plurality of stator coils;
a power supply terminal for each phase which electrically connects the bus ring to a power source side; and
a plurality of coil connection terminals which electrically connects the bus ring to each of the stator coils of the same phase, wherein
each of the bus rings is concentrically laminated on an annular body including the plurality of stator coils in an axial direction.

2. The power supply ring according to claim 1, wherein
each of the bus rings is disposed to be placed between an outer wall surface side and an inner wall surface side on the annular body including the stator coil when viewed in the axial direction.

3. The power supply ring according to claim 1, wherein
each of the bus rings is concentrically disposed side by side in a radial direction, a connecting position with the power supply terminal and a connecting position with the coil connection terminal being provided on the same plane as a main body portion extending in the circumferential direction, and
the power supply terminal and the coil connection terminal are disposed such that a longitudinal direction of the terminals extends along a plane orthogonal to the axis.

4. The power supply ring according to claim 2, wherein
each of the bus rings is concentrically disposed side by side in a radial direction, a connecting position with the power supply terminal and a connecting position with the coil connection terminal being provided on the same plane as a main body portion extending in the circumferential direction, and
the power supply terminal and the coil connection terminal are disposed such that a longitudinal direction of the terminals extends along a plane orthogonal to the axis.

5. The power supply ring according to claim 3, further comprising:
a plurality of holding members which collectively bundles and holds each of the bus rings in a state of being spaced from each other in the radial direction.

6. The power supply ring according to claim 4, further comprising:
a plurality of holding members which collectively bundles and holds each of the bus rings in a state of being spaced from each other in the radial direction.

7. The power supply ring according to claim 5, wherein
the holding member has an engaging portion which fixes each of the bus rings to the stator by being engaged with a portion to be engaged provided in the stator.

8. The power supply ring according to claim 6, wherein
the holding member has an engaging portion which fixes each of the bus rings to the stator by being engaged with a portion to be engaged provided in the stator.

9. The power supply ring according to claim 7, wherein
the portion to be engaged is provided in a coil insulator of the stator coil.

10. The power supply ring according to claim 8, wherein
the portion to be engaged is provided in a coil insulator of the stator coil.

11. The power supply ring according to claim 1, wherein
the bus ring includes a conductive member extending in a circumferential direction along the plurality of stator coils, and an insulating coating which covers the conductive member, and
the coating is an ultraviolet cured coating formed of an ultraviolet curable resin.

12. The power supply ring according to claim 2, wherein
the bus ring includes a conductive member extending in a circumferential direction along the plurality of stator coils, and an insulating coating which covers the conductive member, and
the coating is an ultraviolet cured coating formed of an ultraviolet curable resin.

13. The power supply ring according to claim 3, wherein
the bus ring includes a conductive member extending in a circumferential direction along the plurality of stator coils, and an insulating coating which covers the conductive member, and
the coating is an ultraviolet cured coating formed of an ultraviolet curable resin.

14. The power supply ring according to claim 4, wherein
the bus ring includes a conductive member extending in a circumferential direction along the plurality of stator coils, and an insulating coating which covers the conductive member, and
the coating is an ultraviolet cured coating formed of an ultraviolet curable resin.

15. The power supply ring according to claim 5, wherein
the bus ring includes a conductive member extending in a circumferential direction along the plurality of stator coils, and an insulating coating which covers the conductive member, and
the coating is an ultraviolet cured coating formed of an ultraviolet curable resin.

16. The power supply ring according to claim 6, wherein
the bus ring includes a conductive member extending in a circumferential direction along the plurality of stator coils, and an insulating coating which covers the conductive member, and
the coating is an ultraviolet cured coating formed of an ultraviolet curable resin.

17. The power supply ring according to claim 7, wherein
the bus ring includes a conductive member extending in a circumferential direction along the plurality of stator coils, and an insulating coating which covers the conductive member, and
the coating is an ultraviolet cured coating formed of an ultraviolet curable resin.

18. The power supply ring according to claim 8, wherein
the bus ring includes a conductive member extending in a circumferential direction along the plurality of stator coils, and an insulating coating which covers the conductive member, and
the coating is an ultraviolet cured coating formed of an ultraviolet curable resin.

19. The power supply ring according to claim 9, wherein
the bus ring includes a conductive member extending in a circumferential direction along the plurality of stator coils, and an insulating coating which covers the conductive member, and
the coating is an ultraviolet cured coating formed of an ultraviolet curable resin.

20. The power supply ring according to claim 10, wherein
the bus ring includes a conductive member extending in a circumferential direction along the plurality of stator coils, and an insulating coating which covers the conductive member, and
the coating is an ultraviolet cured coating formed of an ultraviolet curable resin.
